(19) United States
(12) Patent Application Publication
(10) Pub. No.: US 2001/0044753 A1
(43) Pub. Date: Nov. 22, 2001

(54) Service providing system using purchaser terminal and data collating terminal

(76) Inventor: Jiro Hamada, Tokyo (JP)

Correspondence Address: SUGHRUE, MION, ZINN, MACPEAK & SEAS, Pennsylvania Avenue, N.W., Washington, DC, 20037, US

(21) Appl. No.: 09/840,826

(22) Filed: Apr. 25, 2001

(30) Foreign Application Priority Data
May 18, 2000 (JP) 2000-146493

(51) Int. Cl. G06F 17/60

(52) U.S. Cl. 705/26

(57) ABSTRACT

A service providing system is constructed by a network, a commerce provider server connected to the network, a purchaser terminal connected to the network and having an interface with a data holder, a data reader, and a data collating terminal connected between the data reader and the network. The purchaser terminal receives services from the commerce provider server and transmits a selected service and a purchaser identification number to the commerce provider server, so that the commerce provider server stores the selected service in correspondence with the purchaser identification number, and the selected service along with the purchaser identification number is written into the data holder. Then, the data reader reads the selected service and the purchaser identification number from the data holder, and the data collating terminal receives the selected service along with the purchaser identification number in advance, and collates the selected service and the purchaser identification from the data reader with those of the commerce provider server to verify whether or not a purchaser having the data holder is a true one.

### BACKGROUND OF THE INVENTION

1. Field of the Invention

The present invention relates to a service providing system for providing a service such as a railway service.

2. Description of the Related Art

In the prior art, a service provider for providing a variety of services to a purchaser specifies the purchaser by using a ticket such as a concert ticket, an airline ticket, a railway ticket, a commutation ticket or the like, and then provides a service for the purchaser specified by the ticket.

For example, when the service provider provides the purchaser with a railway service to simplify the purchaser's travel, a railway ticket or a railway commutation ticket is sold to the purchaser, so that the purchaser who has purchased the railway ticket or the railway commutation ticket avails himself of the railway, thus providing the service for the purchaser. Also, the service provider sells a prepaid card to utilize the railway service to the purchaser, thus providing the purchaser who has purchased the prepaid card with a railway service equivalent to the charge previously set in the prepaid card.

In the above-mentioned prior art, however, the purchaser who receives such a railway service has to buy a railway ticket or a railway commutation ticket at a specified place, and in a congested time, the purchaser has to queue up at a vending machine for railway tickets or a ticket window, which is troublesome. Also, the railway ticket may be divided into a limited express ticket and a passenger ticket, so that the purchaser who receives the railway service has to hold the respective tickets, which is also troublesome.

On the other hand, the service provider provides the purchaser with a railway service based on a charge set for every railway section. However, one purchaser uses a railway ticket together with a railway commutation ticket, so that not a few purchasers unjustly utilize the railway services of sections that are more than the sections set for the railway tickets the purchasers have purchased. Therefore, the service provider cannot always obtain the charge for every section set by the service provider as a fare.

### SUMMARY OF THE INVENTION

It is an object of the present invention to provide a service providing system and method capable of simplifying the utilization of services and avoiding the unjust utilization of services.

According to the present invention a service providing system is constructed by a network, a commerce provider server connected to the network, a purchaser terminal connected to the network and having an interface with a data holder, a data reader, and a data collating terminal connected between the data reader and the network. The purchaser terminal receives services from the commerce provider server and transmits a selected service and a purchaser identification (ID) number to the commerce provider server, so that the commerce provider server stores the selected service in correspondence with the purchaser identification number, and the selected service along with yhe purchaser identification number is written into the data holder. Then, the data reader reads the selected service and the purchaser ID number from the data holder, and the data collating terminal receives the selected service along with the purchaser identification number in advance, and collates the selected service and the purchaser ID number from the data reader with those of the commerce provider server to verify whether or not a purchaser having the data holder is a true one.

Also, in a service providing method for a service providing system comprising a commerce provider server connected to a network, a purchaser terminal connected to the network and having an interface with a data holder, a data reader, and a data collating terminal connected between the data reader and the network, services are received from the commerce provider server by the purchaser terminal. Then, a selected service of the services along with a purchaser ID number is transmitted from the purchaser terminal to the commerce provider server. Then, the selected service is stored in correspondence with the purchaser identification number in the commerce provider server, and the selected service along with the purchaser ID number is transmitted from the commerce provider to the data collating terminal. Then, the selected service along with the purchaser ID number is written in the data holder. Then, the selected service along with the purchaser ID number is read from the data holder by the data reader. Finally the selected service and the purchaser ID from the data reader are collated with the selected service and the purchaser ID number from the commerce provider to verify whether or not the purchaser having the data holder is a true one.

### BRIEF DESCRIPTION OF THE DRAWINGS

The present invention will be more clearly understood from the description set forth below, wherein:

FIG. 1 is a block circuit diagram illustrating an embodiment of the service providing system according to the present invention; and

FIGS. 2, 3 and 4 are timing diagrams for explaining the operation of the system of FIG. 1.

### DESCRIPTION OF THE PREFERRED EMBODIMENT

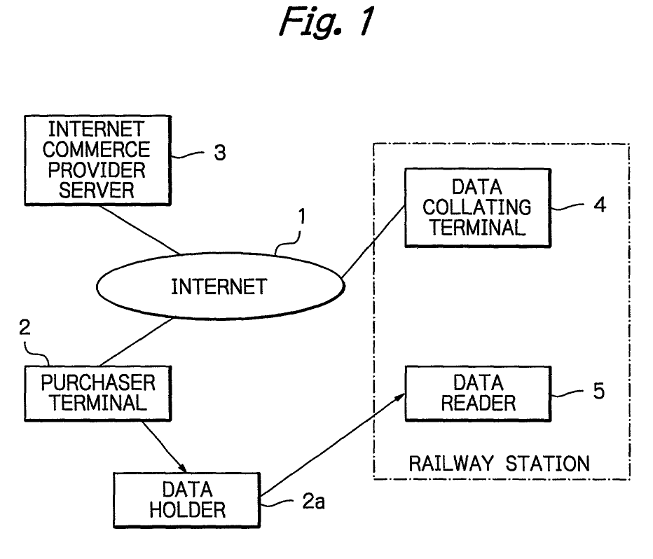

In FIG. 1, which illustrates an embodiment of the service providing system according to the present invention, reference numeral 1 designates the Internet. Note that the Internet 1 can be replaced by a dedicated line or the like.

Also, a purchaser terminal 2 such as a personal computer, a mobile phone or the like is connected via an Internet service provider (not shown) to the Internet 1. The purchaser terminal 2 is a terminal which can be handled by a unidentified person (purchaser) and has a world wide web (WWW) browser or the like capable of accessing homepages through the Internet 1.

The purchaser has a data holder 2a such as an integrated circuit (IC) card or a magnetic card for holding data written by the purchaser terminal 2. For this purpose, the purchaser terminal 2 is provided with an interface capable of writing data into the data holder 2a. Thus, the data holder 2a can store an ID number of the purchaser and a service bought by the purchaser.

Further, an Internet commerce provider server 3 is connected to the Internet 1 in order to provide the purchaser with a predetermined service. The Internet commerce provider server 3 has a memory for storing services bought by purchasers in correspondence with the ID numbers thereof.

Moreover, a data collating terminal 4 is connected to the Internet 1, and a data reader 5 for reading data of the data holder 2a is connected to the data collating terminal 4. The data collating terminal 4 collates the data of the data holder 2a with the data of the Internet commerce provider server 3, to determine whether the service of the data holder 2a is valid or invalid. For example, the data collating terminal 4 and the data reader 5 are provided at a railway station.

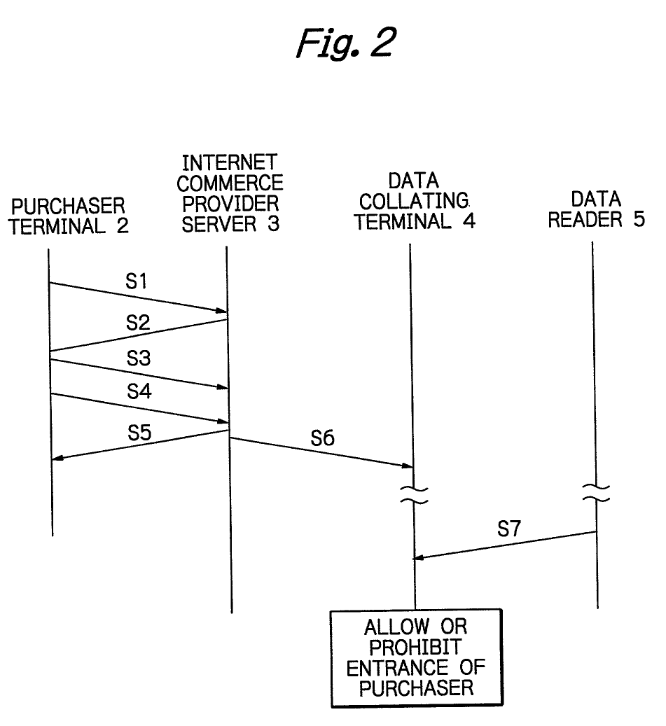

An operation of the system of FIG. 1 is explained next with reference to FIG. 2. Here, the data holder 2a is inserted into the interface of the purchaser terminal 2 in advance.

First, as indicated by S1, when the purchaser inputs a special telephone number into the purchaser terminal 2, the purchaser terminal 2 is connected via the Internet 1 to the Internet commerce provider server 3. Thus, the purchaser terminal 2 can access a homepage of the Internet commerce provider server 3.

Next, as indicated by S2, the Internet commerce provider server 3 distributes service information such as a railway service provided by a railway company to the purchaser terminal 2. As a result, the homepage including a menu of routes, times, sections, fares and the like is displayed on a display unit of the purchaser terminal 2.

Next, the purchaser reads the menu and selects his expected route, time, section, fare and the like. As a result, as indicated by S3, the purchaser terminal 2 transmits the selected service along with his pre-allocated ID number to the Internet commerce provider server 3. As a result, the Internet commerce provider server 3 stores the selected service as a registered service in correspondence with the ID number in the memory thereof.

Next, as indicated by S4 the purchaser carries out a settlement by Internet debit money, credit card information or the like.

Next, as indicated by S5, the Internet commerce provider server 3 returns the registered service along with the ID number to the purchaser terminal 2, so that the registered service along with the ID number is written into the data holder 2a.

Next, as indicated by S6, the Internet commerce provider server 3 transmits the registered service along with the ID number to the collating terminal 4.

Next, after the data holder 2a is removed from the purchaser terminal 2, the purchaser with the data holder 2a goes to a railway station to receive the registered service. Note that the data reader 5 is provided at a ticket checker of the railway station. Therefore, as indicated by S7, the data reader 5 reads the registered service along with the ID number from the data holder 2a and transmits it to the collating terminal 4. As a result, the collating terminal 4 collates the read service with the registered service which is already transmitted from the Internet commerce provider server 3. Only when they are the same, does the data collating terminal 4 allow to further determine whether or not the purchaser can pass the ticket checker in accordance with the registered service. Otherwise, the purchaser is prevented from entering the ticket checker.

Similarly, when the purchaser with the data holder 2a leaves from another railway station after receiving the registered service, the data reader 5 of the other railway station reads the registered service along with the ID number from the data holder 2a and transmits it to the collating terminal 4. As a result, the collating terminal 4 of the other railway station collates the read service with the registered service which is already transmitted from the Internet commerce provider server 3. Only when they are the same, does the data collating terminal 4 of the other station allow to further determine whether or not the purchaser can pass the ticket checker of the other railway station in accordance with the registered service. Otherwise, the purchaser is prevented from passing the ticket checker.

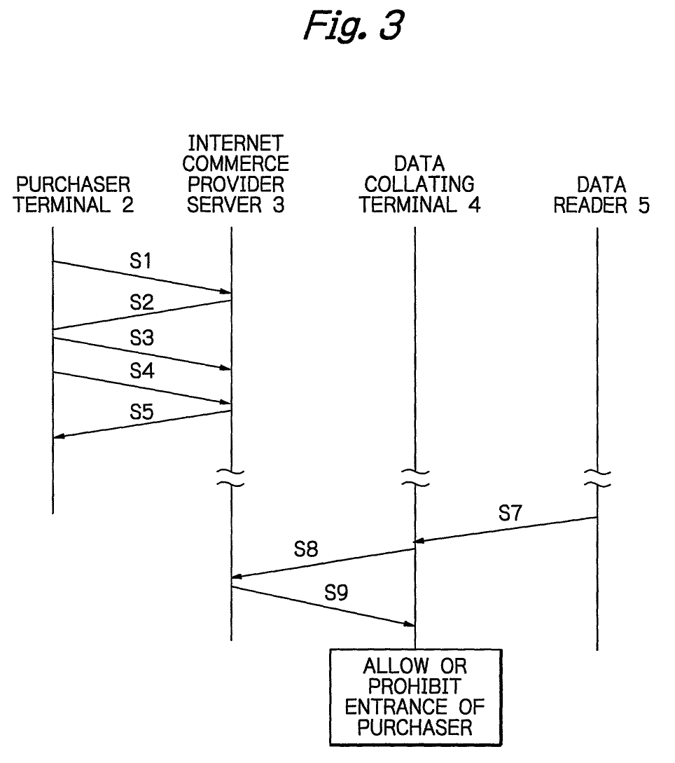

Another operation of the system of FIG. 1 is explained next with reference to FIG. 3.

In FIG. 3, the same processes as indicated by S1, S2, S3, S4 and S5 in FIG. 2 are carried out, however, the Internet commerce provider server 3 does not transmit the register service along the ID number to the collating terminal 4.

Next, after the data holder 2a is removed from the purchaser terminal 2, the purchaser with the data holder 2a goes to a railway station to receive the registered service. Therefore, as indicated by S7, the data reader 5 reads the registered service along with the ID number from the data holder 2a and transmits it to the collating terminal 4.

Next, as indicated by S8, the data collating terminal 4 retrieves the read service along with the ID number in the memory of the Internet commerce provider server 3.

Next, as indicated by S9, the Internet commerce provider server 3 transmits a retrieval result. Only when the retrieval result is affirmative, does the data collating terminal 4 allow to further determine whether or not the purchaser can pass the ticket checker in accordance with the registered service. Otherwise, the purchaser is prevented from entering the ticket checker.

Similarly, when the purchaser with the data holder 2a leaves from another railway station after receiving the registered service, the data reader 5 of the other railway station reads the registered service along with the ID number from the data holder 2a and the data collating terminal 4 of the other station retrieves the read service along the ID number in the memory of the Internet commerce provider server 3. Next, the Internet commerce provider server 3 transmits a retrieval result. Only when the retrieval result is affirmative, does the data collating terminal 4 of the other railway station allow to further determine whether or not the purchaser can pass the ticket checker in accordance with the registered service. Otherwise, the purchaser is prevented from passing the ticket checker.

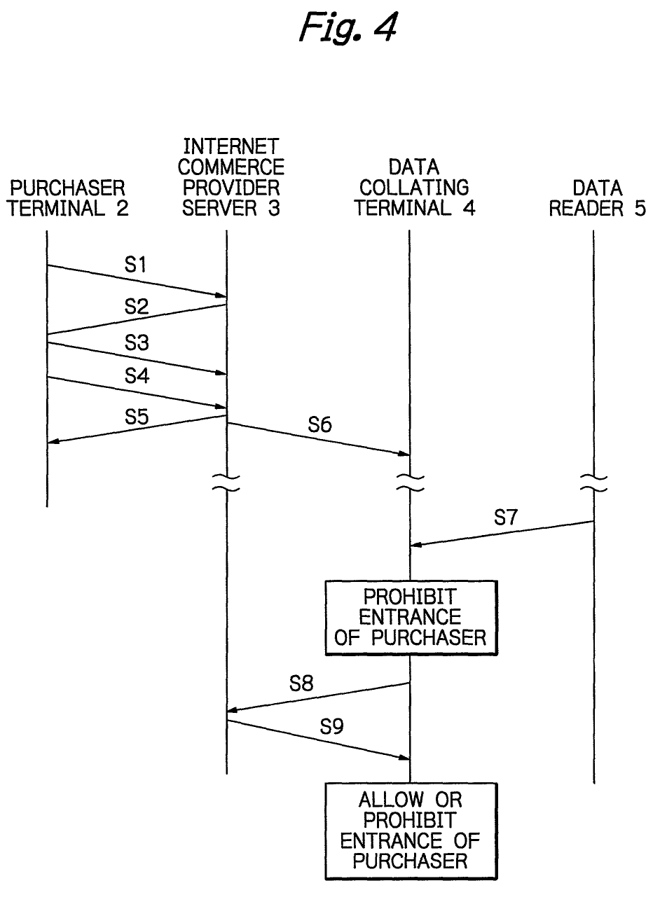

As shown in FIG. 4, the operation as shown in FIG. 2 can be combined with the operation as shown in FIG. 3. In this case, after it is determined that the read service is not in the data collating terminal 4 to prevent the purchaser from entering the ticket checker, the retrieving processes as indicated by S8 and S9 are carried out to again determine whether or not the purchaser can pass the ticket checker.

As explained hereinabove, according to the present invention, the purchaser can obtain a service such as a railway service without visiting a ticket office or a travel agency. Also, since the purchaser does not need a plurality of tickets for individual services, an accident such as a ticket loss and a ticket damage can be avoided to improve the facilities for the purchaser. Further, since the server can easily verify whether a purchaser is a true one, unjust utilization of services can be avoided.

1. A service providing system comprising:
a commerce provider server connected to a network;
a purchaser terminal, connected to said network and having an interface with a data holder, for receiving services from said commerce provider server and transmitting a selected service and a purchaser identification number to said commerce provider server, so that said commerce provider server stores said selected service in correspondence with said purchaser identification number, and said selected service along with said purchaser identification number is written into said data holder;
a data reader for reading said selected service and said purchaser identification number from said data holder;
a data collating terminal, connected between said data reader and said network, for receiving said selected service along with said purchaser identification number in advance, and collating said selected service and said purchaser identification from said data reader with those of said commerce provider server to verify whether or not a purchaser having said data holder is a true one.

2. The system as set forth in claim 1, wherein said data collating terminal retrieves said selected service stored in said commerce provider server by using said purchaser identification number read from said data reader after it is verified that said purchaser is not said true one, and collates said selected service read from said data reader with said retrieved service to verify whether or not said purchaser is said true one.

3. The system as set forth in claim 1, wherein said services are related to a railway service.

4. The system as set forth in claim 1, wherein said network comprises the Internet.

5. A service providing system comprising:
a commerce provider server connected to a network;
a purchaser terminal, connected to said network and having an interface with a data holder, for receiving services from said commerce provider server and transmitting a selected service and a purchaser identification number to said commerce provider server, so that said commerce provider server stores said selected service in correspondence with said purchaser identification number, and said selected service along with said purchaser identification number is written into said data holder;
a data reader for reading said selected service and said purchaser identification number from said data holder;
a data collating terminal, connected between said data reader and said network, for retrieving said selected service stored in said commerce provider server by using said purchaser identification number read from said data reader, and collating said selected service from said data reader with said retrieved service from said commerce provider server to verify whether or not a purchaser having said data holder is a true one.

6. The system as set forth in claim 5, wherein said services are related to a railway service.

7. The system as set forth in claim 5, wherein said network comprises the Internet.

8. A service providing method for a service providing system comprising a commerce provider server connected to a network, a purchaser terminal connected to said network and having an interface with a data holder, a data reader, and a data collating terminal connected between said data reader and said network, said method comprising the steps of:
receiving services from said commerce provider server by said purchaser terminal;
transmitting a selected service of said services along with a purchaser identification number from said purchaser terminal to said commerce provider server;
storing said selected service in correspondence with said purchaser identification number in said commerce provider server;
transmitting said selected service along with said purchaser identification number from said commerce provider to said data collating terminal;
writing said selected service along with said purchaser identification number in said data holder;
reading said selected service along with said purchaser identification number from said data holder by said data reader; and
collating said selected service and said purchaser identification from said data reader with said selected service and said purchaser identification number from said commerce provider to verify whether or not a purchaser having said data holder is a true one.

9. The method as set forth in claim 8, further comprising the steps of:
retrieving said selected service stored in said commerce provider server by using said purchaser identification number read from said data reader, after it is verified that said purchaser is not said true one; and
collating said selected service read from said data reader with said retrieved service to verify whether or not said purchaser is said true one.

10. A service providing method for a service providing system comprising a commerce provider server connected to a network, a purchaser terminal connected to said network and having an interface with a data holder, a data reader, and a data collating terminal connected between said data reader and said network, said method comprising the steps of:
receiving services from said commerce provider server by said purchaser terminal;
transmitting a selected service of said services along with a purchaser identification number from said purchaser terminal to said commerce provider server;
storing said selected service in correspondence with said purchaser identification number in said commerce provider server;
writing said selected service along with said purchaser identification number in said data holder;
reading said selected service along with said purchaser identification number from said data holder by said data reader;
retrieving said selected service stored in said commerce provider server by using said purchaser identification number read from said data reader; and
collating said selected service read from said data reader with said retrieved service to verify whether or not said purchaser is a true one.
